(19) United States
(12) Patent Application Publication
(10) Pub. No.: US 2009/0116762 A1
(43) Pub. Date: May 7, 2009

(54) Content-based gaussian noise reduction for still image, video and film

(76) Inventor: Shu Lin, Santa Clarita, CA (US)

Correspondence Address: Robert D. Shedd;Thomson Licensing LLC, PO Box 5312, PRINCETON, NJ, 08543-5312, US

(21) Appl. No.: 11/921,633

(22) PCT Filed: Jun. 7, 2005
(86) PCT No.: PCT/US2005/019905

§ 371 Date: Dec. 4, 2007

(51) Int. Cl. G06K 9/40

(52) U.S. Cl. 382/261

(57) ABSTRACT

A noise filtering technique for reducing noise in an image comprised of an array of pixels achieves strong filtering over smooth areas and less filtering over rich edge areas. The technique commences by defining M×N neighborhood of pixels for a selected pixel, where M and N are integers. The technique also includes the step of establishing a local filter strength for the selected pixel in accordance with its local variance, and filtering the selected pixel to reduce noise in accordance with its established local filter strength.

### FIELD OF THE INVENTION

The present invention generally relates to image processing and, more particularly, to reduction of image noise.

### BACKGROUND OF THE INVENTION

Random noise often accounts for unwanted artifacts in still images, video and film. Thus, reducing noise while preserving image quality becomes important. The process of reducing noise generally results in smoothing of edges, however, which is undesirable in scenes having areas of stark contrast. Accordingly, a need exists for method of filtering random noise while preserving image contrast.

### SUMMARY OF THE INVENTION

The present invention relates to a method for filtering an image comprised of an array of pixels. The method includes the step of defining an M x N neighborhood of pixels in which a selected pixel is located, wherein M and N are integers. The method also includes the step of establishing a local filter strength for the selected pixel in accordance with its local variance, and filtering the selected pixel to reduce noise in accordance with its established local filter strength.

Another embodiment of the present invention can include a machine-readable storage medium programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a flowchart, which is useful for understanding the present invention.

FIG. 2 depicts an image component, which is useful for understanding the present invention.

FIG. 3 depicts a one-dimensional convolution mask, which is useful for understanding the present invention.

FIG. 4 depicts a two-dimensional convolution mask, which is useful for understanding the present invention.

### DETAILED DESCRIPTION

The present invention relates to a method and a system for reducing noise in images, for instance, still images as well as images contained in video and film. In one embodiment, the strength of one or more noise filters applied to a video signal can be selectively varied to improve image quality. In particular, stronger noise filtering can be applied to areas of an image, which are smooth, while weaker noise filtering can be applied to areas of the image, which have rich texture or stark contrasts, such as object edges.

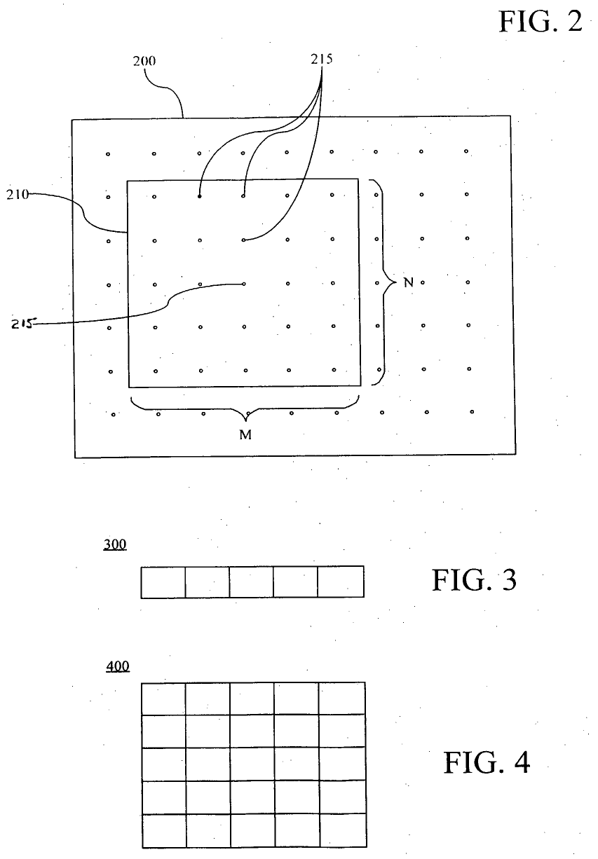

To best understand how the noise filtering technique of the present invention applies different strength noise filtering to different areas, refer to FIG. 2, which depicts an image component 200, i.e., a portion of an image, comprised of a plurality of pixels 215. To determine, the particular filter strength for a particular pixel 215₁ within the plurality of pixels 215, the image component undergoes segmentation into a plurality of neighborhoods, illustrated by neighborhood 210 comprised of M×N pixels, where M and N are integers. Within each neighborhood 210, a local variance is established for each pixel within that neighborhood. Thus, for example, the variance of pixel 215₁ is established within the neighborhood 210, and a local filter strength is established in accordance with that local variance. The pixel 215₁ then undergoes noise reduction filtering based on the local filter strength.

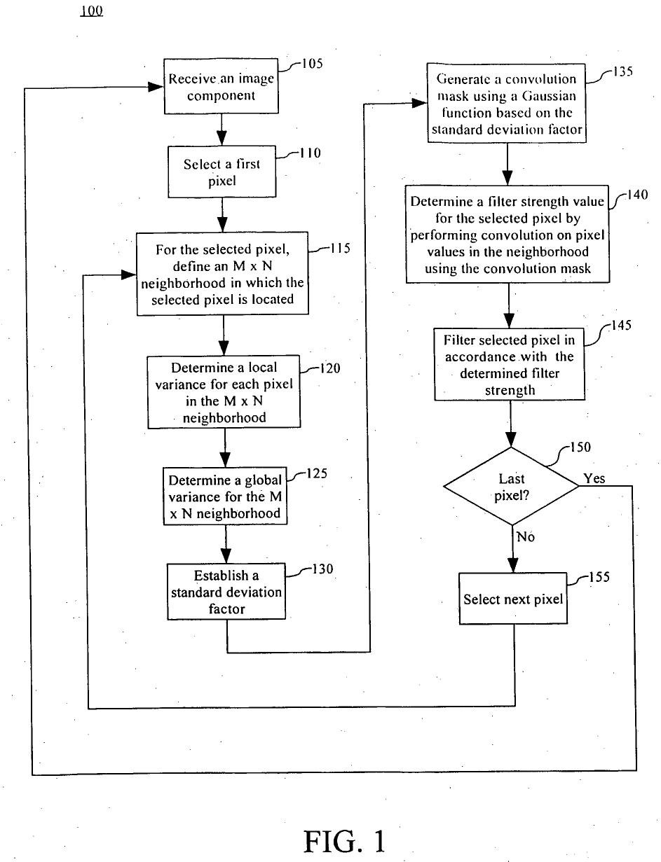

FIG. 1 is a flowchart presenting a method 100 for reducing noise in images in accordance with the present invention. Making reference both to FIG. 1 and FIG. 2, the method 100 begins at step 105 of FIG. 1 with the receipt of the image component 200. The image component 200 can comprise an entire image, or any portion thereof, and can represent a still image or a picture within video or film. For example, the image component 200 can represent at least a portion of a picture, a frame or a field.

Proceeding to step 110 of FIG. 1, a first pixel 215₁ of FIG. 2 undergoes selection from the received image component 200. Continuing to step 115, a neighborhood 210 of pixels can be defined which contains the selected pixel 215₁. For instance, the neighborhood 210 comprises an M×N neighborhood of pixels 215 (including pixel 215, at the center), where M and N are integers representing a number of sequentially positioned pixels in the horizontal and vertical directions, respectively. In the example, the neighborhood 210 is five pixels wide and five pixels high. Accordingly, M and N each equal to five, i.e., a 5×5 matrix. The invention is not limited in the regard, however; the neighborhood 210 can be any width or height. Notwithstanding, the number of computations to be performed to filter the image component 200 correlates to the size of the neighborhood 210. Thus, use of a large neighborhood typically will require greater processing resources in comparison to use of a small neighborhood.

In the example, selection of the neighborhood 210 occurs such that the selected pixel 215₁ resides in the center of the neighborhood. However, selection of the neighborhood 210 can occur such that the selected pixel 215₁ resides elsewhere in the neighborhood. For example, if the selected pixel 215₁ lies at the left edge of a picture, then no pixels will lie to the left of the selected pixel 215₁. The neighborhood 210 therefore can be selected such that the selected pixel 215₁ comprises a leftmost pixel in the neighborhood. In this instance, the size of the neighborhood 210 can be maintained as M×N. or the size of the neighborhood 210 can be adjusted. For example, a 5×5 neighborhood can be reduced to be a 3×5 neighborhood. In yet another arrangement, false pixel values can be inserted to the left of the selected pixel 215₁ in the neighborhood 210.

Proceeding to step 120, a local variance σₗ² of each pixel 2151, 215 with respect to the totality of pixels contained in the neighborhood 210 can be determined. The local variance can be computed by the following equations:

$$mean = \frac{1}{MN} {\sum }_{i}^{M} {\sum }_{j}^{N} {P}_{ij}$$

$${σ}_{l}^{2} = \frac{1}{MN} {\sum }_{i}^{M} {\sum }_{j}^{N} {( {P}_{ij} - mean )}^{2}$$

where Pᵢⱼ is the pixel value at a location (i, j) and mean is the local mean of the pixel values.

The pixel values for determining the local variance σₗ² can be represent values of luminance, chrominance, hue, intensity, saturation, red, green, blue, any combination of these, or any other desired pixel values. In one arrangement, the pixel values used to determine the respective local variances can be limited to pixel values, which are to be filtered. For instance, the color green typically will contain significantly more random noise than red or blue, and thus will be the only color undergoing filtering. In this case, the respective local variance values can be determined based on the pixel values associated with the color green.

At step 125 a global variance σ_{g}² for the M×N neighborhood 210 can be determined. The global variance σ_{g}² can be an average of each of the local variances σₗ² of each of the pixels contained in the neighborhood 210.

At step 130, a standard deviation factor a can be determined based on the global variance σ_{g}² and the local variance σₗ_{ₛ}² of the selected pixel. In particular, the standard deviation factor σ can be determined by the following equation:

$$σ = s * \sqrt{\frac{{σ}_{g}^{2}}{{σ}_{l}^{2}} ,}$$

where s is a global filter strength factor. The global filter strength factor can be a value selected to represent an overall filter strength value. In one arrangement, the global filter strength factor can be user selected. One skilled in the art will appreciate that the term

$$\frac{{σ}_{g}}{{σ}_{{l}_{s}}}$$

is equal to

$$\sqrt{\frac{{σ}_{g}^{2}}{{σ}_{{l}_{s}}^{2}}} ,$$

representing a square root of the ratio of the global variance to the local variance of the selected pixel, where σ_{g} is a global standard deviation and σₗ is a local standard deviation of the selected pixel.

Proceeding to step 135, a convolution mask can be generated based on the standard deviation factor σ. In one arrangement, the convolution mask can be a one-dimensional series of values generated using a Gaussian function. The length of the series can be equal to the number M of sequentially positioned pixels in the horizontal direction, or equal to the number N of sequentially positioned pixels in the vertical direction. The one-dimensional Gaussian function can be given by the equation:

$$G ( x ) = \frac{1}{\sqrt{2 πσ}} {e}^{- \frac{{x}^{2}}{2 {σ}^{2}}}$$

where G(x) is a convolution value for the pixel location represented by the x coordinate, and x represents a coordinate in the convolution mask correlating to a pixel location in the M×N neighborhood, taken with respect to the selected pixel for which the local filter strength is being established. An example of a one-dimensional convolution mask 300 is shown in FIG. 3.

Continuing to step 140, the convolution mask 300 can be used to perform convolution on pixel values in the neighborhood 210. Standard convolution methods known to the skilled artisan can be used to perform the convolution. For instance, two-dimensional convolution can be performed by first convolving the neighborhood 210 with the one-dimensional convolution mask 300 in the x direction, and then convolving the neighborhood 210 in the y direction with the convolution mask 300, or vice versa. The convolution process can generate a single value, which can be used to determine a filter strength value for the selected pixel 215₁.

In another arrangement, the convolution mask can be a two-dimensional M×N matrix of values generated using a two-dimensional Gaussian function. The two-dimensional Gaussian function can be given by the equation:

$$G ( x , y ) = \frac{1}{2 {πσ}^{2}} {e}^{- \frac{{x}^{2} + {y}^{2}}{2 {σ}^{2}}}$$

where x and y represent two-dimensional coordinates in the convolution mask correlating to a pixel location in the M×N neighborhood, taken with respect to the selected pixel. An example of a two-dimensional convolution mask 400 is shown in FIG. 4. The convolution mask 400 can be used to perform two-dimensional convolution on the neighborhood 210 using standard convolution methods known to the skilled artisan to generate a single value which can be used to determine a filter strength value for the selected pixel 215₁.

At step 145, the selected pixel 215₁ can be filtered using the determined filter strength value to reduce noise. Referring to decision box 150, if the selected pixel 215₁ was not the last pixel in the image component 200, a next pixel can be selected, as shown in step 155, and steps 115 through 150 can be repeated for the next selected pixel. If, however, the selected pixel 215₁ was the last pixel in the image component 200, a next image component can be received, as shown in step 105, and steps 110 through 150 can be repeated.

The present invention can be realized in hardware, software, or a combination of hardware and software. The present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general-purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program, software, or software application, in the present context, means any expression, in any language, code or notation, of a set of instructions intended to cause a system having an information processing capability to perform a particular function either directly or after either or both of the following: a) conversion to another language, code or notation; b) reproduction in a different material form. While the foregoing is directed to the preferred embodiment of the present invention, other and further embodiments of the invention may be devised without departing from the basic scope thereof. Further, ordinal references in the specification are provided to describe distinct features of the invention, but such ordinal references do not limit the scope of the present invention. Accordingly, the scope of the present invention is determined by the claims that follow.

1. A method for filtering at least a portion of an image comprised of an array of pixels, comprising the steps of:
(a) defining an M×N neighborhood of pixels about a selected pixel, where M and N are integers;
(b) establishing a local filter strength for the selected pixel in accordance with its local variance; and
(c) filtering the selected pixel to reduce noise in accordance with its established local filter strength.

2. The method according to claim 1 further comprising the step of repeating steps (a)-(c) for each pixel within the portion of the image.

3. The method for filtering an image according to claim 1, wherein said step of establishing the local filter strength comprises:
generating a convolution mask for the M×N neighborhood; and
determining a filter strength value by performing convolution on pixel values in the M×N neighborhood using the generated convolution mask.

4. The method for filtering an image according to claim 3, wherein the convolution mask is generated using a Gaussian function.

5. The method for filtering an image according to claim 4, wherein said step of generating the convolution mask comprises:
establishing a standard deviation factor by determining a ratio of a global variance to the local variance of the selected pixel; and
determining a square root of said ratio;
wherein the global variance is an average variance for all pixels in the M×N neighborhood.

6. The method for filtering an image according to claim 5, wherein said step of establishing a standard deviation factor further comprises multiplying said ratio by a global filter strength factor.

7. The method for filtering an image according to claim 4, further comprising the step of defining the Gaussian function by the equation
$$G ( x , y ) = \frac{1}{2 {πσ}^{2}} {e}^{- \frac{{x}^{2} + {y}^{2}}{2 {σ}^{2}}} ,$$
wherein σ is said standard deviation factor, x and y represent coordinates in the convolution mask correlating to a pixel location in the M×N neighborhood taken with respect to the pixel for which the local filter strength. is being established, and G(x) is a convolution value for the pixel location represented by the x and y coordinates.

8. The method for filtering an image according to claim 5, further comprising the step of defining the Gaussian function by the equation
$$G ( x ) = \frac{1}{\sqrt{2 πσ}} {e}^{- \frac{{x}^{2} + {y}^{2}}{2 {σ}^{2}}} ,$$
wherein σ is said standard deviation factor, x and y represent coordinates in the convolution mask correlating to a pixel location in the M×N neighborhood taken with respect to the pixel for which the local filter strength is being established, and G(x) is a convolution value for the pixel location represented by the x and y coordinates.

9. A machine-readable storage medium, having stored thereon a computer program having a plurality of code sections executable by a machine for causing the machine to filter an image comprised of an array of pixels by performing the steps of:
defining an M×N neighborhood of pixels about a selected pixel, where M and N are integers;
establishing a local filter strength for the selected pixel in accordance with its local variance; and
filtering said selected pixel to reduce noise in accordance with its established local filter strength.

10. The machine-readable storage medium of claim 9, further causing the machine to perform the steps of:
generating a convolution mask for the M×N neighborhood; and
determining a filter strength value by performing convolution on pixel values in the M×N neighborhood using the generated convolution mask.

11. The machine-readable storage medium of claim 10, wherein the convolution mask is generated using a Gaussian function.

12. The machine-readable storage medium of claim 11, wherein said step of generating the convolution mask comprises:
establishing a standard deviation factor by determining a ratio of a global variance to the local variance of the selected pixel; and
determining a square root of said ratio;
wherein the global variance is an average variance for all pixels in the M×N neighborhood.

13. The machine-readable storage medium of claim 12, wherein said step of establishing a standard deviation factor further comprises multiplying said ratio by a global filter strength factor.

14. The machine readable storage of claim 11, further causing the machine to perform the step of defining the Gaussian function by the equation
$$G ( x , y ) = \frac{1}{2 {πσ}^{2}} {e}^{- \frac{{x}^{2} + {y}^{2}}{2 {σ}^{2}}} ,$$
wherein σ is said standard deviation factor, x and y represent coordinates in the convolution mask correlating to a pixel location in the M×N neighborhood taken with respect to the pixel for which the local filter strength is being established, and G(x) is a convolution value for the pixel location represented by the x and y coordinates.

15. The machine-readable storage medium of claim 12, further causing the machine to perform the step of defining the Gaussian function by the equation
$$G ( x ) = \frac{1}{\sqrt{2 πσ}} {e}^{- \frac{{x}^{2} + {y}^{2}}{2 {σ}^{2}}} ,$$
wherein σ is said standard deviation factor, x and y represent coordinates in the convolution mask correlating to a pixel location in the M×N neighborhood taken with respect to the pixel for which the local filter strength is being established, and G(x) is a convolution value for the pixel location represented by the x and y coordinates.
